(19) United States
(12) Patent Application Publication
(10) Pub. No.: US 2003/0048284 A1
(43) Pub. Date: Mar. 13, 2003

(54) Method of selecting a point in a layout

(76) Inventor: I-Lang Chang, HsinChu City (TW)

Correspondence Address: BIRCH STEWART KOLASCH & BIRCH, PO BOX 747, FALLS CHURCH, VA, 22040-0747, US

(21) Appl. No.: 09/950,703

(22) Filed: Sep. 13, 2001

(51) Int. Cl. G09G 5/00

(52) U.S. Cl. 345/662

(57) ABSTRACT

A method of selecting a point in a layout, which firstly receives a first point when a user performs a first action. Then, if the user performs a second action within a predetermined period of time after performing the first action, the first point is returned as a selected point. If the user does not perform a second action within a predetermined period of time after performing the first action, a snap operation is then activated automatically to search for a second point on at least one entity of the layout according to a predetermined criterion. After activating the snap operation, the second point is returned as the selected point if the second point is found, and the first point is returned as the selected point if the second point is not found.

### BACKGROUND OF THE INVENTION

1. Field of the Invention

The invention relates in general to a method of selecting a point in a layout and, more particularly, to a method of selecting a point in a layout that can automatically activate a snap operation according to the actions performed by a user.

2. Description of Related Art

It is convenient for users to design layouts with a CAD system as a drawing tool. A CAD system can construct different kinds of entities automatically, such as lines, arcs, circles, rectangles and polygons, so that a user can design a layout more efficiently. A CAD system also provides useful functions, which enable users to edit the entities in a layout, to measure the distance between two points, or to view the layout with different scales.

While using a CAD system, it is important for a user to accurately select a point in a layout. For instance, while measuring the distance between two specific points, the user must select the start point and the end point accurately to get the correct result. In view of this, the state-of-the-art CAD system provides a so-called “snap” function. For example, if a user wants to select an end point of a line, he/she can firstly enable the snap function, then select any part of the line. Since the snap function is enabled, the system will return the end point of the line to the user automatically. With the aid of the snap function, users can select points more precisely and efficiently.

However, the prior-art snap function has some disadvantages. Firstly, a user must enable the snap function manually. While the snap function is not required, the user must also disable the snap function manually. Since a CAD system user always performs the point-selecting action frequently, it annoys the user if he/she must switch the snap function every time he/she selects a point.

Secondly, when snapping a point on an entity, a user must select the entity first. For example, if the user wants to select the end point of a line, he/she must select any other part of the line. In other words, the user can not select the neighborhood of the line to snap the end point of the line. In conventional CAD systems, for a user to select an entity, the CAD system provides the user with a small square. When a part of the entity is within the square, the user can then select the entity by, for example, click a button of the mouse. However, when the layout is very complicated, sometimes it is difficult to select a specific entity using the square because the distances between entities of the layout are too close.

### SUMMARY OF THE INVENTION

in view of the above-mentioned problems, an objective of the invention is to provide a method of selecting a point in a layout, which method facilitates the point-selecting operations of a user.

To achieve the objective, the method of selecting a point in a layout according to the invention firstly receives a first point when a user performs a first action. If the user performs a second action within a predetermined period of time after performing the first action, then the method returns the first point as a selected point. If the user does not perform a second action within a predetermined period of time after performing the first action, the method then searches for a second point on at least one entity of the layout according to a predetermined criterion. Then, the method returns the second point as the selected point if the second point is found, and returns the first point as the selected point if the second point is not found.

The invention also provides a CAD system, which includes a storage means, a receiving module and a selected point-determining module. The storage means stores at least one entity of a layout. The receiving module receives a first point when a user performs a first action. If the user performs a second action within a predetermined period of time after performing the first action, the selected point-determining module returns the first point as a selected point. If the user does not perform a second action within a predetermined period of time after performing the first action, the selected point-determining module searches for a second point on the entity of the layout according to a predetermined criterion. Then, if the second point is found, the selected point-determining module returns the second point as the selected point. If the second point is not found, the selected point-determining module returns the first point as the selected point.

According to one aspect of the invention, the first action is a mouse-button-pressing action, and the second action is a mouse-button-releasing action. The predetermined criterion is that the distance between the first point and the second point is smaller than a predetermined value.

According to the invention, a user can activate a snap operation simply by, for example, press a button of a mouse for a predetermined period of time. Therefore, it is convenient for a user to switch between a snap mode and a non-snap mode.

According to the invention, the snap operation can snap a point on a nearest entity in a layout. Therefore, it becomes easier for a user to select a point on a specific entity of the layout.

### BRIEF DESCRIPTION OF THE DRAWINGS

Other objects, features and advantages of the present invention will become apparent from the following detailed description of the preferred but non-limiting embodiment. The description is made with reference to the accompanying drawings, wherein:

FIG. 1 is a block diagram showing a computer that serves as an operating environment for a preferred embodiment of the invention;

FIG. 2 is a schematic view showing the a program code means according to the preferred embodiment of the invention;

FIG. 3 is a flowchart showing the procedures the method of selecting a point in a layout according to the preferred embodiment of the invention;

FIG. 4 is a flowchart showing the procedures the snap operation according to the preferred embodiment of the invention;

FIG. 5 is a schematic diagram showing an example condition while performing of the snap operation;

FIGS. 6 to 8 are screen shots further illustrating the procedures of the snap operation; and

FIG. 9 is a screen shot showing the result with the snap operation not being activated;

FIG. 10 is a schematic diagram showing a CAD system operating under network environment according to the preferred embodiment of the invention; and

FIG. 11 is a flowchart for further describing another feature of the CAD system operating under network environment according to the preferred embodiment of the invention.

### DETAILED DESCRIPTION OF THE PREFERRED EMBODIMENTS

The invention will be apparent from the following detailed description, which proceeds with reference to the accompanying drawings, wherein the same references relate to the same elements.

### Hardware Overview

FIG. 1 is a block diagram illustrating a computer 10 that serves as an operating environment for a preferred embodiment of the invention. Referring to FIG. 1, the computer 10 includes at least one input device 11, including a cursor control device, and at least one output device 12, including a display monitor. The computer 10 has at least one high-speed central processing unit (CPU) 13 and a memory 14. The input device, the output device, the memory and CPU are interconnected and communicate through at least one bus structure.

The input device 11 and output device 12 may be conventional peripheral devices coupled to or installed within the computer. For instance, the input device 11 may comprise a cursor control device such as a mouse. The output device 12 may be a conventional display monitor. For example, the output device 12 may be a conventional CRT display monitor or a LCD display monitor.

The CPU 13 may be a conventional design including an ALU 131 for performing computations, registers 132 for temporary storage of data and instructions, and a control unit 133 for controlling operation of the computer 10. The memory 14 may includes high-speed memory device 141 in the form of a random access memory (RAM) or read only memory (ROM) semiconductor devices, and storage device 142 in the form of floppy disks, hard disks, or CD-ROM. The memory 14 can comprise a variety of alternative components having a variety of storage capacities.

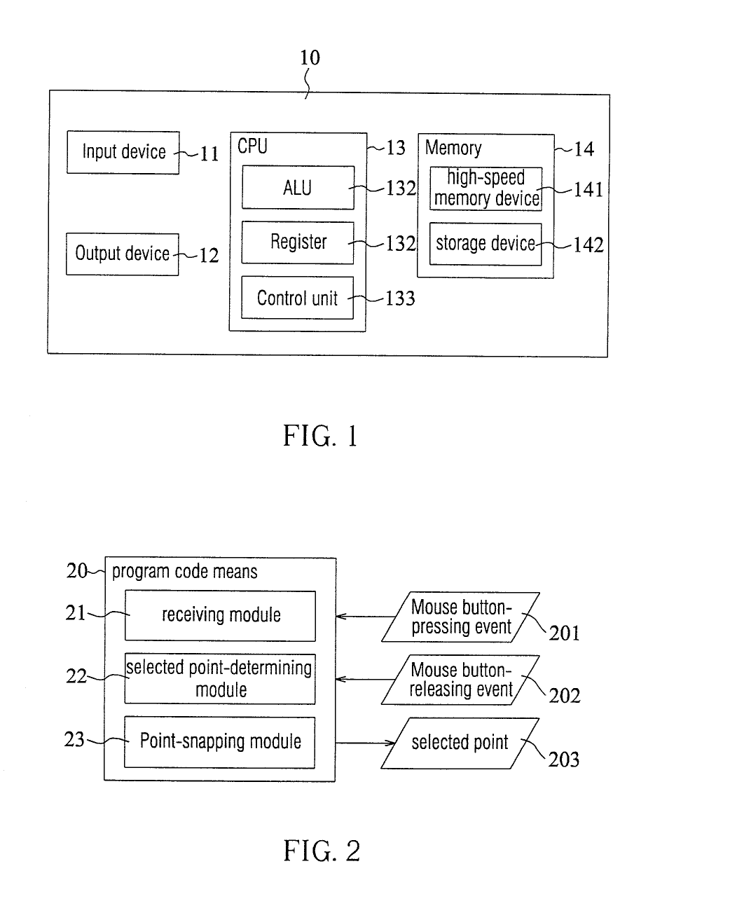

In a preferred embodiment, the method is realized by a program code means 20 installed in the computer 10. Referring to FIG. 2, the program code means 20 installed in the computer 10 according to the preferred embodiment of the invention is a CAD system, and includes a receiving module 21, a selected point-determining module 22 and a point-snapping module 23. With the above-mentioned modules, after receiving the mouse button-pressing event 201 and the mouse button-releasing event 202, the program code means 20 returns a selected point 203. The detail description of the procedures of the program code means 20 will be given below.

### Procedures of the Point-Selecting Method

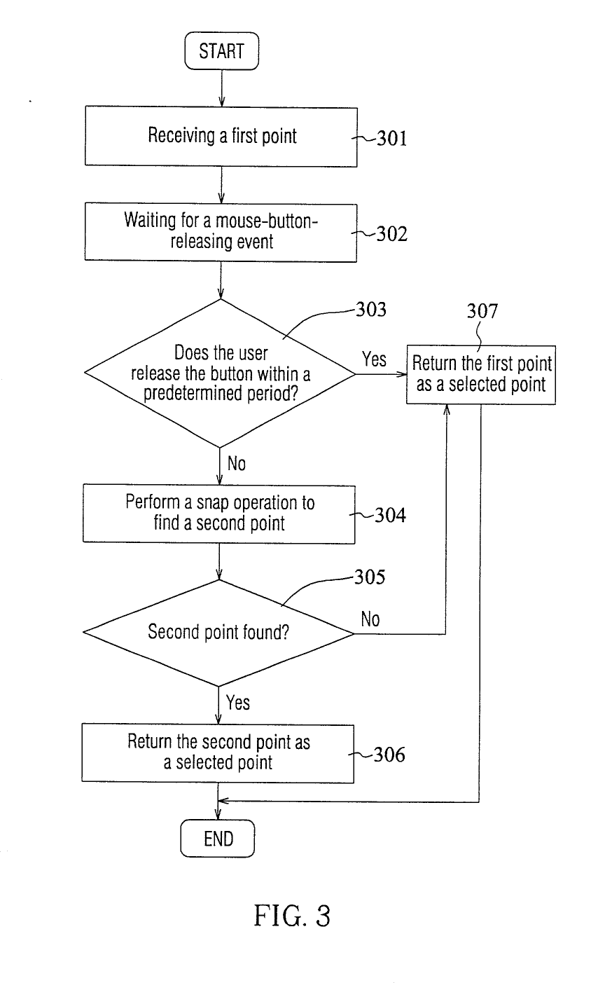

FIG. 3 is a flowchart showing the procedures the computer 10 performs when executing the program code means 20. Referring to FIG. 3, when a user performs a mouse button-pressing action to select a point, a mouse button-pressing event is received by the user interface of the CAD system. Then, in procedure 301, the receiving module 21 receives a first point by, for example, getting the X-coordinate and the Y-coordinate from of the mouse-event object, and set the X-coordinate and the Y-coordinate to be the coordinate of the first point.

After receiving the first point, the program code means 20 waits for a mouse button-releasing event in procedure 302.

The selected point-determining module 22 judges if the user releases the button within a predetermined period of time, for example, 1 second, in procedure 303. This can be accomplished by listening whether a mouse-button-releasing event is generated. If the button is released within 1 second, the program code means 20 then returns the first point as a selected point in procedure 307. If the button is released more than 1 second after the button-pressing action, i.e., the a mouse-button-releasing event is not detected within 1 second, then the program code means 20 calls the point-snapping module 23 to perform a snap operation attempting to find a second point based on a predetermined criterion in procedure 304.

Procedure 305 judges whether the second point is found. If the second point is not found, then the program code means 20 proceeds to procedure 307 to return the first point as a selected point. If the second point is found, then the program code means 20 proceeds to procedure 306 to return the second point as the selected point.

### Procedures of the Snap Operation

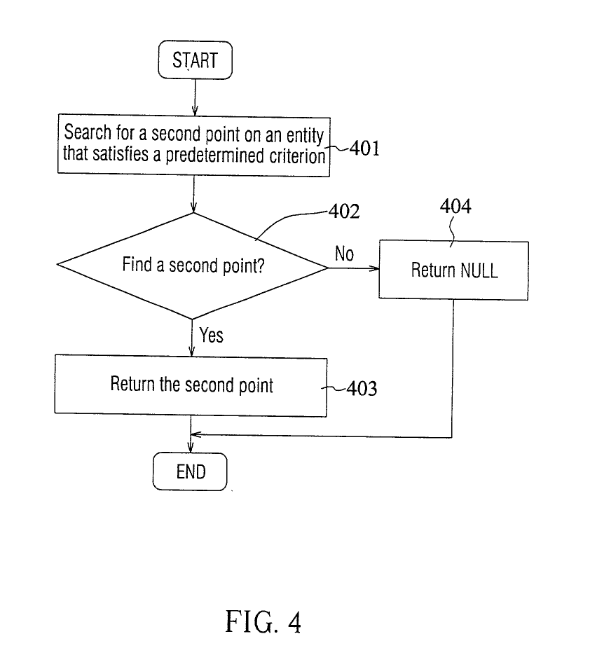

The detailed procedures of the snap operation will be described hereinbelow with reference to FIG. 4.

Referring to FIG. 4, when performing a snap operation, the point-snap module 23 firstly searches for a second point on an entity that satisfies a predetermined criterion in procedure 401. In the preferred embodiment, the predetermined criterion is that: (1) the distance between the first point and the second point is smaller than a predetermined value, and (2) the distance between the first point and the second point has a smallest value than the distance between the first point and any other point on any other entity.

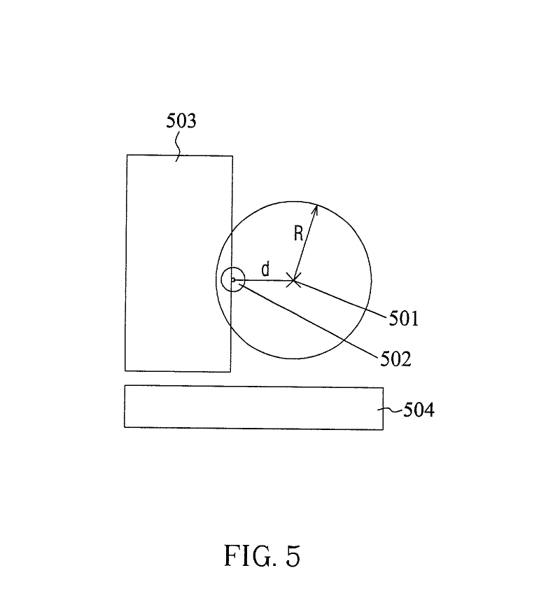

For example, referring to FIG. 5, when performing a snap operation, the point-snap module 23 first searches if any entity lies within a circular region. The center 501 of the circular region is the first point, and the radius R of the circular region is the predetermined value. The radius R may be reset according to the actual need of the user. For instance, for a crowded area of the layout, the radius R may be set smaller to speed up the snap operation.

As shown in FIG. 5, a part of the entity 503 is within the circular region, while the entity 504 is not within the circular region. Under this situation, the point-snap module 23 excludes the entity 504, and tries to find a second point 502 on the entity 503 by performing, for example, the Norm algorithm. The Norm algorithm is an algorithm that can find the shortest distance d between the entity 503 and the first point 501. The second point 502 is a point on the entity 503 that the distance between the second point and the first point is d.

Procedure 402 judges whether the second point is found. If the second point is found, then the point-snapping module 23 returns the second point in procedure 403. If the second point is not found, then the point-snapping module 23 returns NULL in procedure 404. In the preferred embodiment, the second point can not be found means that there exists no entity in the circular region described above.

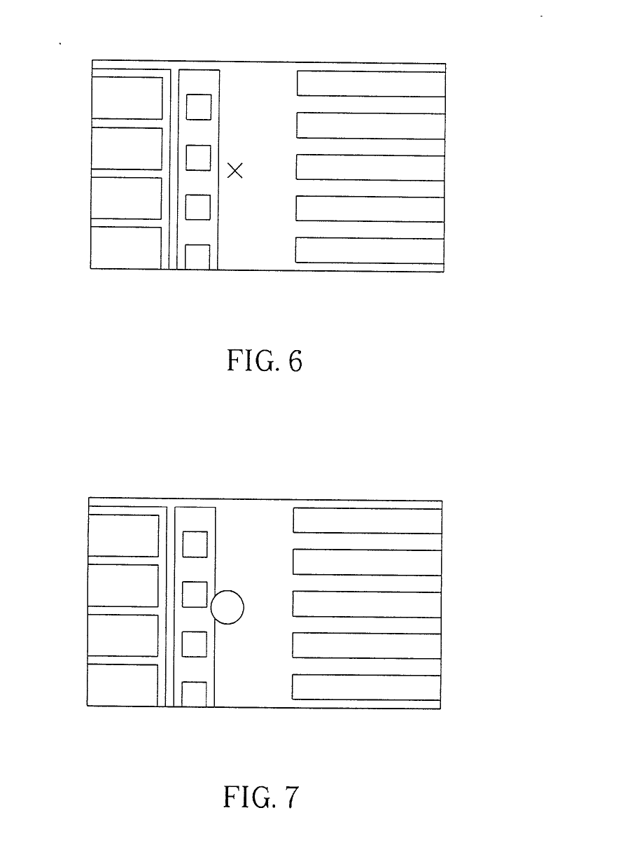

FIGS. 6 to 8 are screen shots which further illustrates the procedures of the snap operation. Referring to FIG. 6, when a user wants to select a point and presses the button on a mouse, the receiving module 21 receives a first point, and the position of which is shown on the screen using an “X” symbol.

If the user holds the button more than, for example, 1 second, then the snap operation is activated automatically. As shown in FIG. 7, a solid circle is used to represent the circular region in which the point-snapping module searches for a second point. In the preferred embodiment, as described above, the point-snapping module utilizes the conventional “Norm” algorithm to find the second point on an entity within the circular region.

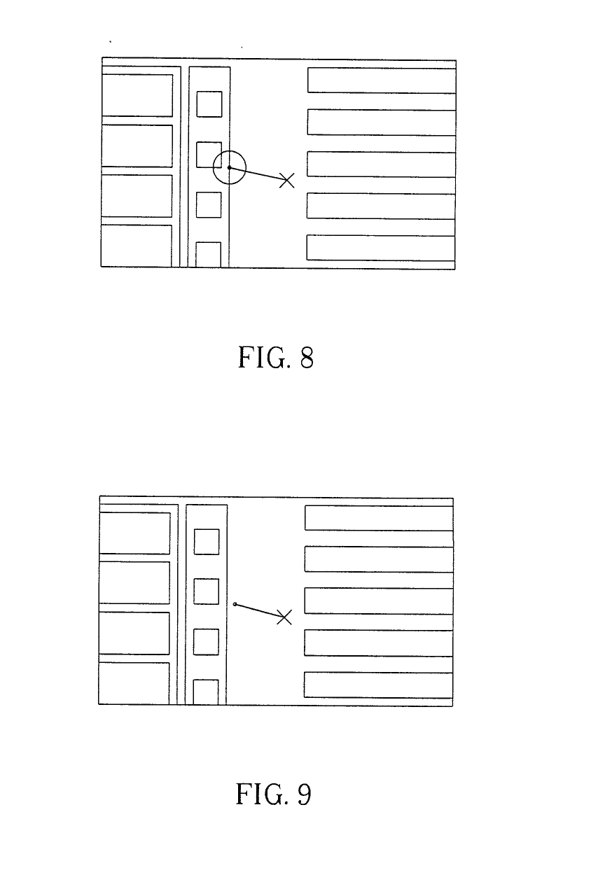

Referring to FIG. 8, if the second point is found, the second point is then represented by a dot and a hollow circle as a selected point. Please note that the second point lies on an entity of the layout, and the distance between the first point and the second point is shorter than the distance between any other point on the entity and the layout.

Referring to FIG. 9, if the user releases the button of the mouse within I second after he/she presses the button, the snap operation is not activated. The first point (a small dot shown in FIG. 9) is then returned as the selected point.

Since a user can activate a snap operation simply by, for example, holding a button of a mouse for a predetermined period of time, it is convenient for the user to switch between a snap mode and a non-snap mode when selecting a point in a layout. Therefore, with the assistance of the above-mentioned method, the layout-designing efficiency of the user can be improved.

Furthermore, the snap operation according to the preferred embodiment of the invention can snap a point on a nearest entity in a layout. Therefore, it becomes easier for a user to select a point on a specific entity.

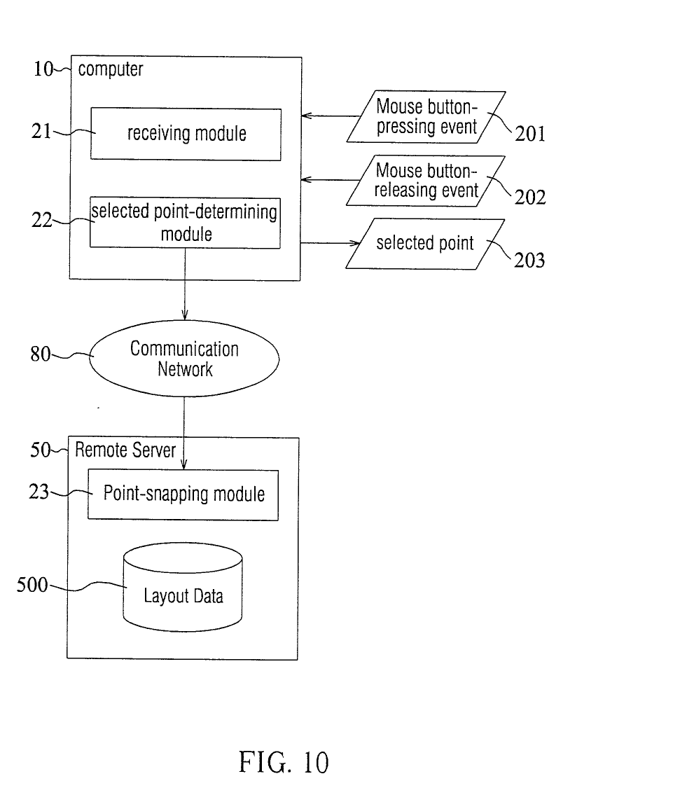

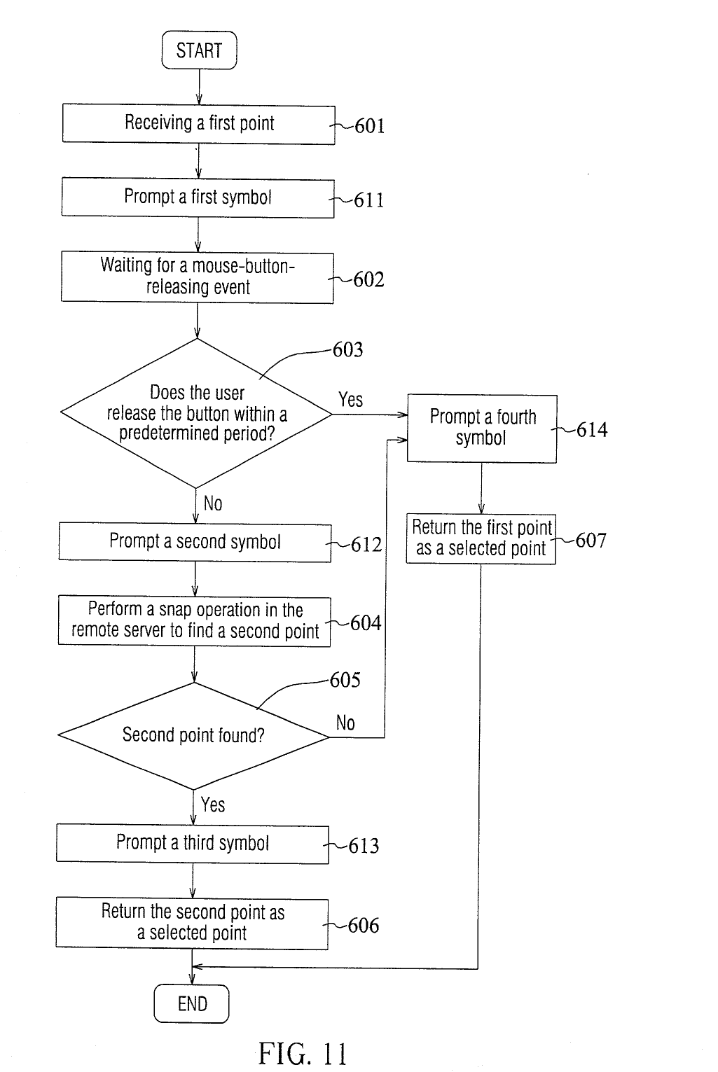

It should be noted that according to the preferred embodiment of the invention, the user is able to know the snap operation states intuitively, even if the snap operation is operated under network environment. Referring to FIG. 10, which shows a CAD system operating under network environment. The point-snapping module 23 is provided in a remote server 50. The layout data 500 is also stored in the remote database server 50. When the user is selecting a point, the point-selecting states can be prompted to the user, and this state-prompt action is independent to the data transmission between the computer 10 and the remote server 50, and is also independent to the snap operation performed at the remote server 50.

To further explain the feature of the preferred embodiment of the invention mentioned above, please refer to FIG. 11. In FIG. 11, each of the steps 601 to 607 corresponds to the steps 301 to 307 shown in FIG. 3, respectively. The steps 611 to 614 are steps describing the state-prompting actions at different states. The first symbol in step 611 refers the “X” symbol shown in FIG. 6. The second symbol is the solid circle shown in FIG. 7. The third symbol is the dot and the hollow circle shown in FIG. 8. The fourth symbol is the small dot shown in FIG. 9.

Note that in step 604 (which corresponds to step 304 in FIG. 3), the snap operation is performed at the remote server 50. However, since the state-prompting steps 611 to 614 can be handled at the computer 10, the state-prompting steps are independent of the snap operation performed at the remote server 50. The user can obtain a quick response and aware of what state it is while selecting a point. Therefore, the user is able to know the snap operation states intuitively.

Many changes, modifications, variations and other uses and applications of the subject invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of selecting a point in a layout, comprising:
receiving a first point when a user performs a first action;
if the user performs a second action within a predetermined period of time after performing the first action, returning the first point as a selected point; and
if the user does not perform a second action within a predetermined period of time after performing the first action,
searching for a second point on at least one entity of the layout satisfying a predetermined criterion,
returning the second point as the selected point if the second point is found, and
returning the first point as the selected point if the second point is not found.

2. The method according to claim 1, wherein the first action is a mouse-button-pressing action.

3. The method according to claim 1, wherein the second action is a mouse-button-releasing action.

4. The method according to claim 1, wherein the predetermined criterion comprises that a distance between the first point and the second point is smaller than a predetermined value.

5. The method according to claim 1, wherein the predetermined criterion comprises that the distance between the first point and the second point has a smallest value than the distance between the first point and any other point on any other entity in the layout.

6. A CAD system, comprising:
a receiving module for receiving a first point when a user performs a first action; and
a point-snapping module for performing a snap operation if the user does not perform a second action within a predetermined period of time, wherein the snap operation comprises:
searching for a second point on at least one entity of a layout satisfying a predetermined criterion,
returning the second point as a selected point if the second point is found, and
returning the first point as the selected point if the second point is not found.

7. The CAD system according to claim 6, further comprising:
a selected point-determining module for judging whether the user performs the second action within the predetermined period of time.

8. The CAD system according to claim 7, wherein the selected point-determining module
returns the first point as the selected point if the user performs the second action within the predetermined period of time; and
calls the point-snapping module if the user does not perform the second action within the predetermined period of time.

9. The CAD system according to claim 6, wherein the first action is a mouse-button-pressing action.

10. The CAD system according to claim 6, wherein the second action is a mouse-button-releasing action.

11. The CAD system according to claim 6, wherein the predetermined criterion comprises that the distance between the first point and the second point is smaller than a predetermined value.

12. The CAD system according to claim 6, wherein the predetermined criterion comprises that the distance between the first point and the second point has a smallest value than the distance between the first point and any other point on any other entity in the layout.

13. A computer-readable storage medium used to direct a computer to perform the process of:
receiving a first point when a user performs a first action;
if the user performs a second action within a predetermined period of time after performing the first action, returning the first point as a selected point; and
if the user does not perform a second action within a predetermined period of time after performing the first action,
searching for a second point on at least one entity of the layout satisfying a predetermined criterion,
returning the second point as the selected point if the second point is found, and
returning the first point as the selected point if the second point is not found.

14. The computer-readable storage medium according to claim 13, wherein the first action is a mouse-button-pressing action.

15. The computer-readable storage medium according to claim 13, wherein the second action is a mouse-button-releasing action.

16. The computer-readable storage medium according to claim 13, wherein the predetermined criterion comprises that a distance between the first point and the second point is smaller than a predetermined value.

17. The computer-readable storage medium according to claim 13, wherein the predetermined criterion comprises that the distance between the first point and the second point has a smallest value than the distance between the first point and any other point on any other entity in the layout.

18. A method of selecting a point in a layout, comprising:
receiving a first point when a user performs a first action;
prompting a first symbol showing the position of the first point;
if the user performs a second action within a predetermined period of time after performing the first action, prompting a fourth symbol and returning the first point as a selected point; and
if the user does not perform a second action within a predetermined period of time after performing the first action,
searching for a second point on at least one entity of the layout satisfying a predetermined criterion,
prompting a second symbol indicating the predetermined criterion;
prompting a third symbol and returning the second point as the selected point if the second point is found, and
prompting the fourth symbol and returning the first point as the selected point if the second point is not found.

19. The method according to claim 18, wherein the first action is a mouse-button-pressing action.

20. The method according to claim 18, wherein the second action is a mouse-button-releasing action.

21. The method according to claim 18, wherein the predetermined criterion comprises that a distance between the first point and the second point is smaller than a predetermined value.

22. The method according to claim 18, wherein the predetermined criterion comprises that the distance between the first point and the second point has a smallest value than the distance between the first point and any other point on any other entity in the layout.
